(19) United States
(12) Patent Application Publication
(10) Pub. No.: US 2025/0235936 A1
(43) Pub. Date: Jul. 24, 2025

(54) PARTIAL SEPARATION CONTINUOUS HIGH-SPEED ULTRASONIC VIBRATION MACHINING METHOD

(71) Applicant: Beihang University, Beijing (CN)

(72) Inventors: Deyuan Zhang, Beijing (CN); Zhiyong Huang, Beijing (CN); Jiteng Li, Beijing (CN); Mingshuo Zhang, Beijing (CN)

(73) Assignee: Beihang University, Beijing (CN)

(21) Appl. No.: 18/738,856

(22) Filed: Jun. 10, 2024

(30) Foreign Application Priority Data
Jan. 19, 2024 (CN) 202410078699.7

(51) Int. Cl. B23B 37/00; B23B 29/12

(52) U.S. Cl. CPC B23B 37/00; B23B 29/125; B23B 2220/36; B23B 2231/24

(57) ABSTRACT

A partial separation continuous high-speed ultrasonic vibration machining method is provided, which belongs to the technical field of machining. Through the method, partial separation continuous high-speed ultrasonic vibration machining further breaks through a limitation on a critical feed rate on the basis of breaking through a critical cutting speed in complete separation intermittent high-speed ultrasonic vibration machining, which can achieve dynamically variable cutting thicknesses through transverse vibration or transverse component vibration during continuous cutting of a cutting edge, so that wave ridge structures are formed on a chip bottom surface and a machined surface to cause completely new partial separation of wave ridge on a cutting interface, to facilitate entering of cutting liquid into a cutting area, and to reduce cutting force and cutting heat during machining. The method significantly improves the material removal rate and prolongs the tool life.

### CROSS-REFERENCE TO RELATED APPLICATION

This patent application claims the benefit and priority of Chinese Patent Application No. 2024100786997 filed with the China National Intellectual Property Administration on Jan. 19, 2024, the disclosure of which is incorporated by reference herein in its entirety as part of the present application.

### TECHNICAL FIELD

The present disclosure belongs to the technical field of machining, relates to an ultrasonic vibration machining technology for aerospace difficult-to-machine materials such as titanium alloy, wrought superalloy, and powder superalloy in aerospace manufacturing, and in particular to a partial separation continuous high-speed ultrasonic vibration machining method.

### BACKGROUND

In the field of aerospace manufacturing, when a key manufactured part is machined with the purposes of improving functional attributes and prolonging service life, a surface integrity feature is considered as a key factor in evaluating finishing surface quality. Aerospace manufacturer replaces a tool before a generally accepted tool wear threshold defined by an ISO standard (ISO 3685 for turning and ISO 8688 for milling) is reached to eliminate a risk of surface damage caused by premature degradation of a cutting edge. For aerospace difficult-to-machine materials such as titanium alloy, wrought superalloy, and powder superalloy, finishing performed on an aerospace part is usually performed at a relatively low cutting speed due to high cutting temperature arisen and high strength exhibited during machining. Machining efficiency can be improved or tool life can be prolonged to a certain extent by using cutting tools made of high-performance materials, various cooling and lubricating technologies, special machining processes, and methods such as tool geometrical shape optimization. However, the needs of aerospace manufacturing can still not be met. For years, even at a low cutting speed, the tool life is short and surface integrity is limited, which are two basic problems limiting the machinability of these materials in a finishing stage. Therefore, prolonging the tool life and improving the machining efficiency are urgent and eternal pursuits of aerospace manufacturing industry on the premise of giving priority to meet the requirement of surface quality.

Ultrasonic vibration machining is a special processing technology, which has many advantages in machining difficult-to-machine materials, but always faces the problem of low machining efficiency. Traditional one-dimensional ultrasonic vibration machining and two-dimensional elliptical ultrasonic vibration machining have limitations on a critical cutting speed, which limit the increasing in cutting speed. The cutting speed of conventional machining has currently exceeded those of these two types of vibration machining. Complete separation intermittent high-speed ultrasonic vibration cutting method breaks through the limitation on the critical cutting speed, which doubles the cutting speed compared with existing ultrasonic vibration machining and the conventional machining. The method has a good effect on prolonging the tool life, but the machining efficiency is still low due to a low feed rate. Trajectory separation ultrasonic vibration machining fundamentally limits the increasing in ultrasonic vibration machining efficiency in theory. To further increase ultrasonic machining efficiency, the trajectory is required not to be separated. The cutting speed of the difficult-to-machine materials is low, and the continuous radial vibration has a large impact on the tool tip, so the tool life is short, correspondingly a high-speed continuous ultrasonic radial vibration cutting method has narrow range of machining parameters and poor effects.

In conclusion, the existing ultrasonic vibration machining technologies (traditional one-dimensional ultrasonic machining, two-dimensional elliptical ultrasonic machining, and complete separation intermittent high-speed ultrasonic machining (that is, high-speed precision interrupted ultrasonic vibration cutting method)) solves the problem about machinability of the aerospace difficult-to-machine materials, but still has the problems of short tool life, low machining efficiency, and poor surface quality. On this basis, it is urgent to provide a novel efficient machining technology suitable for the aerospace difficult-to-machine materials to solve the above problems.

### SUMMARY

A purpose of the present disclosure is to provide a partial separation continuous high-speed ultrasonic vibration machining method, which can significantly prolong the tool life and improve the machining efficiency on the premise of ensuring the machining quality, so as to solve the problems of short tool life, low machining efficiency, and poor surface quality in machining aerospace difficult-to-machine materials.

To achieve the above purpose, the present disclosure provides the following solutions:

The present disclosure provides a partial separation continuous high-speed ultrasonic vibration machining method, including:

step 1, mounting an ultrasonic vibration tool holder on a corresponding machine tool, in a base surface of a cutting tool, inducing transverse vibration or transverse component vibration of a cutting edge of the cutting tool on the ultrasonic vibration tool holder in a feed direction;
step 2, matching ultrasonic vibration parameters and cooling parameters according to cutting amount, so that a condition for partial separation of a wave ridge between a rake face of the cutting tool and a chip bottom surface, or between a flank face of the cutting tool and a machining surface is satisfied in a case that the cutting tool performs continuous cutting on a tool tip trajectory, where the cutting amount includes three parameters: cutting speed, feed rate, and cutting depth of the cutting tool, the ultrasonic vibration parameters include three parameters: vibration amplitude, frequency, and vibration form, and the cooling parameters include three parameters: type of coolant, coolant pressure, and coolant application position; and
step 3, starting a cooling system, an ultrasonic vibration system, and the machine tool, and performing a partial separation continuous high-speed ultrasonic vibration machining process of the cutting tool on a workpiece.

Optionally, the machine tool in step 1 is at least one of a lathe, a milling machine, a drilling machine, a grinding machine, and a machining center.

Optionally, the cutting tool in step 1 includes at least one of a turning tool, a milling tool, a drilling bit, a grinding head, a reamer, and a countersink drill.

Optionally, the ultrasonic vibration tool holder in step 1 includes at least one of a turning tool holder, a milling tool holder, a drilling bit holder, a grinding head holder, a reamer holder, and a countersink drill holder.

Optionally, the cutting tool in step 1 is made of at least one of cemented carbide, ceramic, cermet, cubic boron nitride, and diamond.

Optionally, in a case that the partial separation continuous high-speed ultrasonic vibration machining method is combined with a turning method, both a partial separation continuous high-speed transverse ultrasonic vibration turning method and a partial separation continuous high-speed elliptical ultrasonic vibration turning method are included; in a case that the partial separation continuous high-speed ultrasonic vibration machining method is combined with a milling method, both a partial separation continuous high-speed elliptical ultrasonic vibration milling method and a partial separation continuous high-speed transverse ultrasonic vibration plunge milling method are included; in a case that the partial separation continuous high-speed ultrasonic vibration machining method is combined with a grinding method, both a partial separation continuous high-speed elliptical ultrasonic vibration grinding method and a partial separation continuous high-speed transverse ultrasonic vibration grinding method are included; in a case that the partial separation continuous high-speed ultrasonic vibration machining method is combined with a drilling method, both a partial separation continuous high-speed elliptical ultrasonic vibration drilling method and a partial separation continuous high-speed transverse ultrasonic vibration drilling method are included; in a case that the partial separation continuous high-speed ultrasonic vibration machining method is combined with a reaming method, both a partial separation continuous high-speed transverse ultrasonic vibration reaming method and a partial separation continuous high-speed elliptical ultrasonic vibration reaming method are included; and in a case that the partial separation continuous high-speed ultrasonic vibration machining method is combined with a countersinking method, both a partial separation continuous high-speed transverse ultrasonic vibration countersinking method and a partial separation continuous high-speed elliptical ultrasonic vibration countersinking method are included.

Optionally, in a case that the partial separation continuous high-speed ultrasonic vibration machining method is used for cylindrical turning, f>2A, and in a case that a vibration direction of the cutting tool is parallel to the feed direction, a vibration equation of the cutting tool is:

z=A sin(2πFt),
where, F is ultrasonic vibration frequency, A is actual ultrasonic vibration amplitude during turning, f is feed rate, tis time, and θ is an angle corresponding to an arc between point D on the cutting edge of the cutting tool and a tool tip point; at point D on the cutting edge:
heights of nominal wave ridges on the chip bottom surface and the machining surface are respectively as follows:

h_{c}=2A sin θ;

hₛ=2A sin θ;
heights of extruded wave ridges on the chip bottom surface and the machining surface are respectively as follows:

h_{cE}=2B sin θ;

h_{sE}=2C sin θ;
heights of residual wave ridges on the chip bottom surface and the machining surface are respectively as follows:

$$\begin{matrix}{h}_{cR} = 2 ( A - B ) sin θ ; \\ {h}_{sR} = 2 ( A - C ) sin θ ;\end{matrix}$$

where, B and C are actually removed amplitudes after being extruded and rebounding at nominal amplitude A;
maximum separation clearances between the rake face and the chip bottom surface, as well as between the flank face and the machining surface are respectively:

C_{c}=h_{cE};

Cₛ=h_{sE};
cycle lengths of the nominal wave ridges on the chip bottom surface and the machining surface are respectively as follows:

$$\begin{matrix}{λ}_{c} = \frac{{v}_{ch}}{F} ; \\ {λ}_{s} = \frac{v}{F} ;\end{matrix}$$

where, ν_{ch} is flow speed of chips, and ν is cutting speed; and
duty cycles between the rake face and the chip bottom surface, as well as between the flank face and the machining surface in a separation stage are respectively as follows:

$$\begin{matrix}{D}_{c} = \frac{{λ}_{cE}}{{λ}_{c}} = \frac{{λ}_{cE} F}{{v}_{ch}} ; \\ {D}_{s} = \frac{{λ}_{sE}}{{λ}_{s}} = \frac{{λ}_{cE} F}{v} .\end{matrix}$$

Optionally, the condition for partial separation of the wave ridge between the rake face of the cutting tool and the chip bottom surface is as follows:

0<C_{c}<G; and
the condition for partial separation of the wave ridge between the flank face of the cutting tool and the machining surface is as follows:

0<Cₛ<G,
where, G is an upper limit of the height of the extruded wave ridge.

Optionally, direction of the transverse vibration or the transverse component vibration in step 1 is perpendicular to the cutting speed of the cutting tool, and vibration forms of the transverse vibration or the transverse component vibration include one-dimensional vibration, two-dimensional vibration, three-dimensional vibration, or elliptical vibration.

Optionally, the type of coolant includes at least one of oil-based cutting liquid, oil-based cutting mist, water-based cutting liquid, water-based cutting mist, liquid nitrogen, and air.

Optionally, in step 3, when the cooling system is started, a coolant is capable of being sprayed to a cutting area from the rake face of the cutting tool, the flank face of the cutting tool, or both the rake face of the cutting tool and the flank face of the cutting tool.

Compared with the prior art, the present disclosure achieves the following technical effects:

The partial separation continuous high-speed ultrasonic vibration machining method proposed in the present disclosure is performed according to the following steps: step 1, mounting an ultrasonic vibration tool holder on a machine tool, in a base surface of a cutting tool, transverse vibration or transverse component vibration of a cutting edge of the cutting tool on the ultrasonic vibration tool holder in a feed direction is induced; step 2, matching ultrasonic vibration parameters and cooling parameters according to cutting amount, so that a condition for partial separation of a wave ridge between a rake face of the cutting tool and a chip bottom surface, and/or between a flank face of the cutting tool and a machining surface is satisfied in a case that the cutting tool performs continuous cutting on a tool tip trajectory, where the cutting amount includes three parameters: cutting speed, feed rate, and cutting depth of the cutting tool; the ultrasonic vibration parameters include three parameters: vibration amplitude, frequency, and vibration form, and the cooling parameters include three parameters: type of coolant, coolant pressure, and coolant application position; and step 3, starting a cooling system, an ultrasonic vibration system, and the machine tool, and performing a partial separation continuous high-speed ultrasonic vibration machining process of the cutting tool on a workpiece. Through the above steps, partial separation continuous high-speed ultrasonic vibration machining further breaks through a limitation on a critical feed rate on the basis of breaking through a critical cutting speed in complete separation intermittent high-speed ultrasonic vibration machining, thereby completely breaking through limitations on critical cutting parameters, and significantly increasing the material removal rate. In the present disclosure, dynamically variable cutting thicknesses are achieved through transverse vibration or transverse component vibration during continuous cutting of the cutting edge, so that wave ridge structures are formed on the chip bottom surface and the machining surface to cause completely new partial separation of the wave ridge on a cutting interface, to facilitate entering of cutting liquid into a cutting area, and to reduce cutting force and cutting heat during machining. Compared with the existing ultrasonic machining technology and conventional machining technology, the present disclosure significantly improves the material removal rate and prolongs the tool life on the premise of ensuring the machining quality, and can be applied to multiple cutting processes such as turning, milling, drilling, and grinding to achieve efficient finishing and precision machining of a complex part made of difficult-to-machine materials.

### BRIEF DESCRIPTION OF THE DRAWINGS

To describe the technical solutions in the embodiments of the present disclosure or in the prior art more clearly, the following briefly describes the drawings required for describing the embodiments. Apparently, the drawings in the following description are merely some embodiments of the present disclosure. For those skilled in the art, other drawings can also be obtained from these drawings without creative efforts.

FIG. 1 is a schematic flowchart of a partial separation continuous high-speed ultrasonic vibration machining method disclosed in an embodiment of the present disclosure;

FIG. 2 is a schematic diagram of wave ridge separation on a cutting interface disclosed in an embodiment of the present disclosure;

FIG. 3 is a sectional view taken along line P-P of FIG. 2;

FIG. 4 is an enlarged schematic diagram of a structure of part I in FIG. 3;

FIG. 5 is a schematic diagram of dynamic processes of wave ridge extrusion and wave ridge separation of a flank face;

FIG. 6 is a schematic diagram of a fluctuation surface at a carnivorous peristome of nepenthes alata;

FIG. 7 is a schematic diagram of partial separation of a fluctuation interface at a peristome of nepenthes alata for increasing lubrication and reducing viscosity;

FIG. 8 is a schematic diagram of a machined surface formed by the partial separation continuous high-speed ultrasonic vibration machining method;

FIG. 9 is a schematic diagram of a machined surface formed by an existing conventional machining method;

FIG. 10 is a schematic diagram of a chip bottom surface formed by the partial separation continuous high-speed ultrasonic vibration machining method;

FIG. 11 is a schematic diagram of a chip bottom surface formed by the existing conventional machining method;

FIG. 12 is a comparison diagram of tool wear between the partial separation continuous high-speed ultrasonic vibration machining method of the present disclosure and the conventional machining method;

FIG. 13 is a comparison diagram of surface roughness Ra between the partial separation continuous high-speed ultrasonic vibration machining method of the present disclosure and the conventional machining method;

FIG. 14 is a comparison diagram of relationship between tool life and cutting speed between the partial separation continuous high-speed ultrasonic vibration machining method of the present disclosure and the conventional machining method;

FIG. 15 is a schematic diagram of partial separation continuous high-speed ultrasonic vibration turning disclosed in Embodiment 2 of the present disclosure;

FIG. 16 is a schematic diagram of partial separation continuous high-speed ultrasonic vibration milling disclosed in Embodiment 3 of the present disclosure;

FIG. 17 is a schematic diagram of partial separation continuous high-speed ultrasonic vibration grinding disclosed in Embodiment 3 of the present disclosure;

FIG. 18 is a schematic diagram of partial separation continuous high-speed ultrasonic vibration drilling disclosed in Embodiment 4 of the present disclosure;

FIG. 19 is a schematic diagram of partial separation continuous high-speed ultrasonic vibration reaming disclosed in Embodiment 4 of the present disclosure; and

FIG. 20 is a schematic diagram of partial separation continuous high-speed ultrasonic vibration countersinking disclosed in Embodiment 4 of the present disclosure.

Reference signs are as follows:
1 workpiece; 2 turning tool; 3 milling tool; 4 grinding head; 5 drilling bit; 6 reamer; 7 countersink drill; 8 insect foot; 9 peristome wave ridge structure; and 10 interfacial liquid membrane.

### DETAILED DESCRIPTION OF THE EMBODIMENTS

Technical solutions in embodiments of the present disclosure will be clearly and completely described below with reference to accompanying drawings in the embodiments of the present disclosure. Apparently, the described embodiments are merely part rather than all of the embodiments of the present disclosure. Based on the embodiments of the present disclosure, all other embodiments obtained by those of conventional skill in the art without creative work fall within the scope of protection of the present disclosure.

One of the purposes of the present disclosure is to provide a partial separation continuous high-speed ultrasonic vibration machining method, which can significantly prolong the tool life and improve the machining efficiency on the premise of ensuring the machining quality, so as to solve the problems of short tool life, low machining efficiency, and poor surface quality in machining aerospace difficult-to-machine materials.

In order to make the above-mentioned purpose, features, and advantages of the present disclosure more apparent and more comprehensible, the present disclosure is further described in detail below with reference to the drawings and specific implementations.

### Embodiment 1

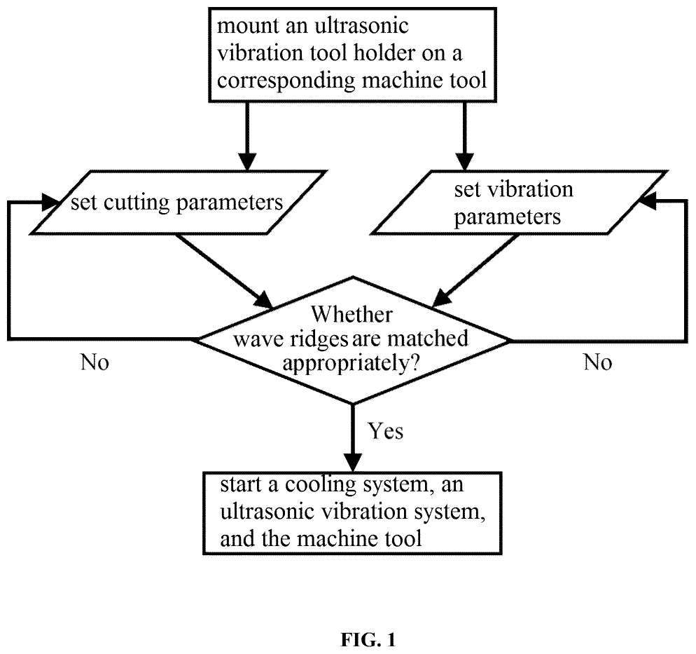

As shown in FIG. 1, this embodiment provides a partial separation continuous high-speed ultrasonic vibration machining method, including the following implementation steps.

In step 1, an ultrasonic vibration tool holder is mounted on a corresponding machine tool, in a base surface of a cutting tool, transverse vibration or transverse component vibration of a cutting edge of the cutting tool of the ultrasonic vibration tool holder in a feed direction is induced. By combining different ultrasonic vibration forms, different cutting processes, and types of parts with different shapes, parts with different shapes can be machined by multiple cutting processes.

In step 2, ultrasonic vibration parameters and cooling parameters are reasonably matched according to cutting amount, so that a condition for partial separation of a wave ridge between a rake face of the tool and a chip bottom surface, and/or between a flank face of the tool and a machining surface is satisfied in a case that the cutting tool performs continuous cutting on a tool tip trajectory (that is, the condition for partial separation of the wave ridge is satisfied on at least one of the two positions: between the rake face of the tool and the chip bottom surface, as well as between the flank face of the tool and the machining surface). The “cutting amount” refers to three parameters: cutting speed, feed rate, and cutting depth, and ranges of the parameters include all process conditions that can cause partial separation of the wave ridge between the tool and chips, as well as between the tool and the machining surface. The “ultrasonic vibration parameters” refer to three parameters: vibration amplitude, frequency, and vibration form. A range of the vibration amplitude includes all vibration conditions that can cause partial separation of the wave ridge between the tool and the chips, as well as between the tool and the machining surface. The “cooling parameters” refer to three parameters: type of coolant, coolant pressure, and coolant application position. A coolant may be oil-based cutting liquid, oil-based cutting mist, water-based cutting liquid, water-based cutting mist, liquid nitrogen, or air. The coolant may be sprayed to a cutting area from the rake face of the tool, the flank face of the tool, or both the rake face of the tool and the flank face of the tool. The coolant pressure is determined according to conditions of the machine tool and requirements of process effect.

In step 3, a cooling system, an ultrasonic vibration system, and the machine tool are started, and a partial separation continuous high-speed ultrasonic vibration machining process is performed.

In this embodiment, the “machine tool” in step 1 includes, but is not limited to, various machine tools such as a lathe, a milling machine, a drilling machine, a grinding machine, or a machining center that can perform various types of cutting processes.

In this embodiment, the “ultrasonic vibration tool holder” in step 1 may be of multiple types and specifications, and includes, but is not limited to, the ultrasonic vibration tool holders with different shapes and a variety of vibration forms suitable for different processes such as turning, milling, drilling, grinding, reaming, and countersinking and different part machining positions.

In this embodiment, the “cutting tool” in step 1 includes, but is not limited to, a turning tool 2, a milling tool 3, a drilling bit 5, a grinding head 4, a reamer 6, and a countersink drill 7 that can perform various types of cutting processes. The tool may be made of various types of materials such as cemented carbide, ceramic, cermet, cubic boron nitride, or diamond.

In this embodiment, direction of the transverse vibration or the transverse component vibration in the “in a base surface of a cutting tool, transverse vibration or transverse component vibration of a cutting edge of the cutting tool of the ultrasonic vibration tool holder in a feed direction is induced” in step 1 is perpendicular to the cutting speed of the cutting tool. Actual situations are different according to different machining processes, for example, transverse vibration of face turning is actually in a radial direction of a workpiece 1. Vibration forms of the “transverse vibration or transverse component vibration” may be one-dimensional vibration, two-dimensional vibration, three-dimensional vibration, or the like.

In this embodiment, the “different cutting processes” in step 1 mainly includes the followings: (1) combined with a turning method, both the partial separation continuous high-speed transverse ultrasonic vibration turning method and partial separation continuous high-speed elliptical ultrasonic vibration turning method are included; (2) combined with a milling method, both the partial separation continuous high-speed elliptical ultrasonic vibration milling method and partial separation continuous high-speed transverse ultrasonic vibration plunge milling method are included; (3) combined with a grinding method, both the partial separation continuous high-speed elliptical ultrasonic vibration grinding method and partial separation continuous high-speed transverse ultrasonic vibration grinding method are included; (4) combined with a drilling method, both the partial separation continuous high-speed elliptical ultrasonic vibration drilling method and partial separation continuous high-speed transverse ultrasonic vibration drilling method are included; (5) combined with a reaming method, both the partial separation continuous high-speed transverse ultrasonic vibration reaming method and partial separation continuous high-speed elliptical ultrasonic vibration reaming method are included; and (6) combined with a countersinking method, both the partial separation continuous high-speed transverse ultrasonic vibration countersinking method and partial separation continuous high-speed elliptical ultrasonic vibration countersinking method are included.

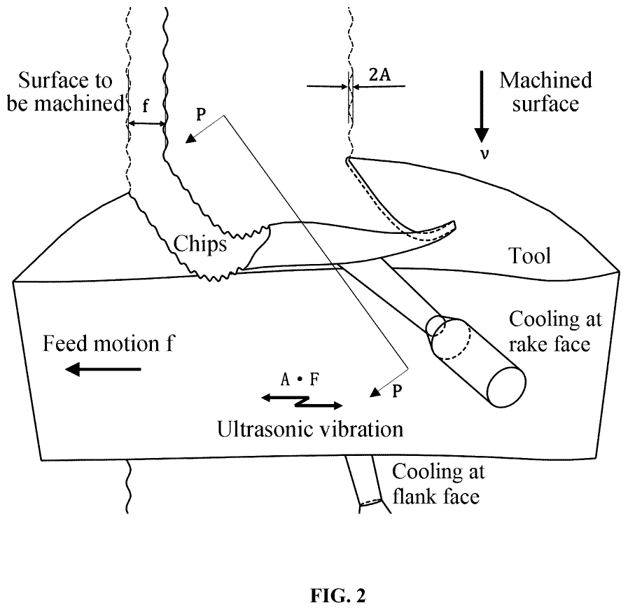

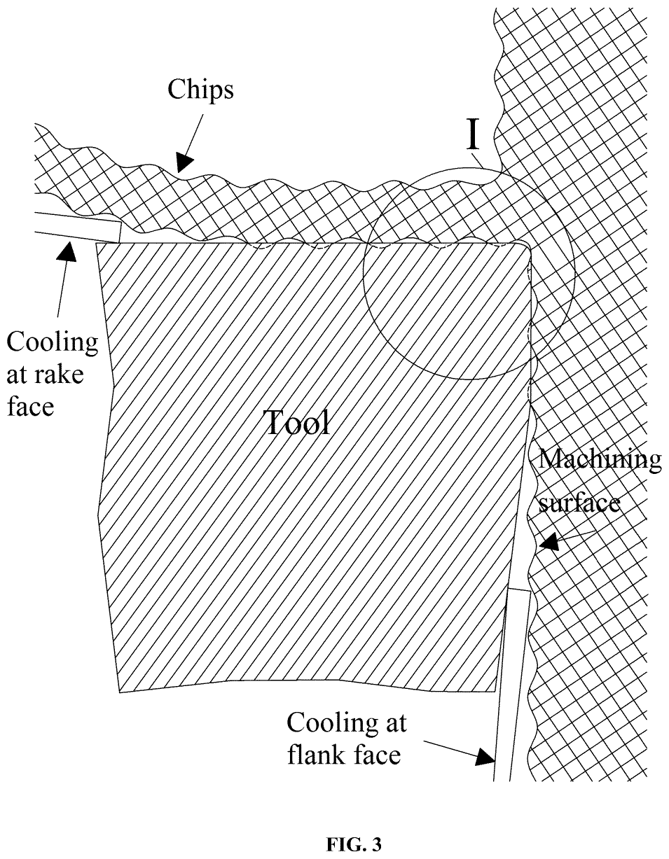

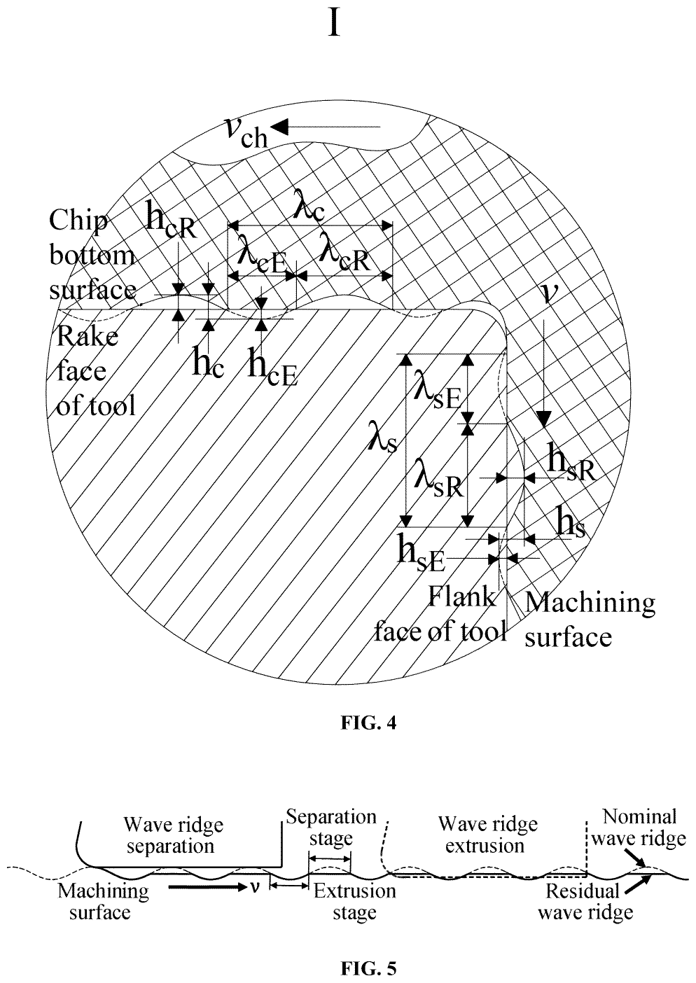

In this embodiment, “separation” in the “partial separation of a wave ridge” in step 2 refers to wave ridge separation. The separation does not refer to the separation of a tool tip trajectory, but refers to the wave ridge separation between the rake face of the tool and the chip bottom surface, as well as between the flank face of the tool and the machining surface, which belongs to the separation between faces, and a tool tip is not separated. For conventional machining, although the tool is provided with a clearance angle, an actual clearance angle of the tool is 0° due to inevitable wear of the flank face during machining. In the whole tool life, the flank face is always in close contact with the machining surface. In conventional machining, the chips flow tightly against the rake face, and the rake face of the tool is also always in close contact with the chip bottom surface. FIG. 2 to FIG. 5 are schematic diagrams of wave ridge separation on a cutting interface. In the present technical solution, there are two stages in one wave ridge formation cycle: wave ridge separation and wave ridge extrusion. In the wave ridge extrusion stage of one wave ridge formation cycle, a tool face will interfere and extrude a formed wave ridge when a current wave ridge is formed; and in the wave ridge separation stage of one wave ridge separation cycle, a clearance is formed between the tool face and the interfered, extruded, and rebounding wave ridge when a current wave ridge is formed, so that faces are separated from each other, but the tool tip is not separated. Cutting areas between the chip bottom surface and the rake face of the tool, as well as between the flank face of the tool and the machining surface are periodically opened, due to the wave ridge separation between the rake face and the flank face of the cutting tool, which facilitates entry of cutting liquid into the cutting areas to improve cutting conditions of the tool and the machining surface, increase lubrication, reduce wear, and cool down, and is beneficial to prolonging the tool life and improving the surface quality of the workpiece.

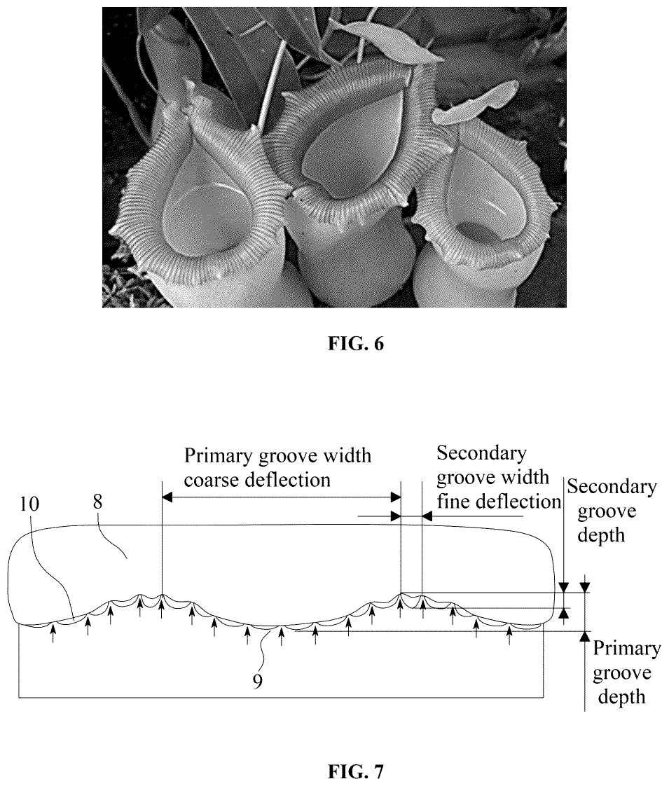

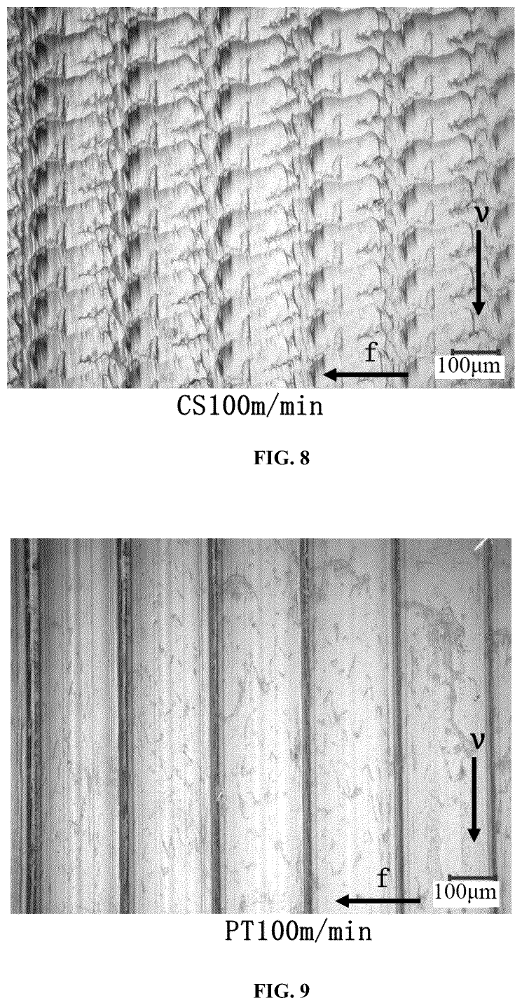

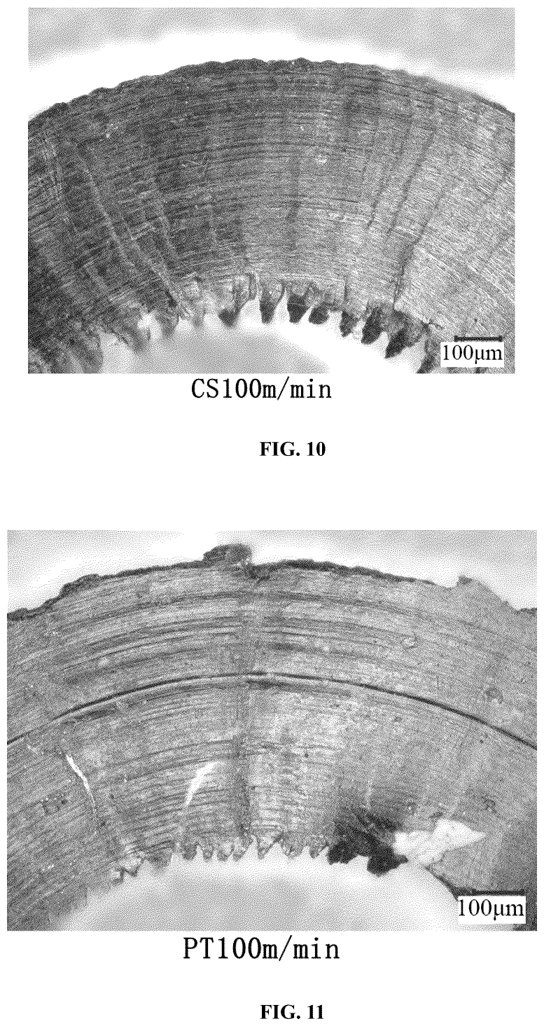

In the above described partial separation continuous high-speed ultrasonic vibration machining method, a principle of partial separation is used to form a micro clearance to promote the entry of the cutting liquid into the cutting areas and achieve the purposes of increasing lubrication and reducing viscosity, which is similar to partial separation of a fluctuation surface at a peristome of nepenthes alata for increasing lubrication and reducing viscosity. FIG. 6 is a fluctuation surface at a carnivorous peristome of the nepenthes alata, which is covered with wave ridge structures. As shown in FIG. 7, when an insect foot steps on a wave ridge structure at the peristome of the nepenthes alata, a micro flow channel for partial separation will be formed between the insect foot and the wave ridge structure. Nepenthes alata can improve the insect catching ability by filling liquid into the microchannel to form an interfacial liquid film to increase the lubrication effect. FIG. 8 and FIG. 9 are structures of machined surfaces formed by the partial separation continuous high-speed ultrasonic vibration machining method in the present technical solution and a conventional machining method, respectively. The machined surface formed by the partial separation continuous high-speed ultrasonic vibration machining method in the present technical solution has an obvious wave ridge structure, which proves that there is wave ridge separation in partial separation continuous high-speed ultrasonic vibration machining in the present technical solution.

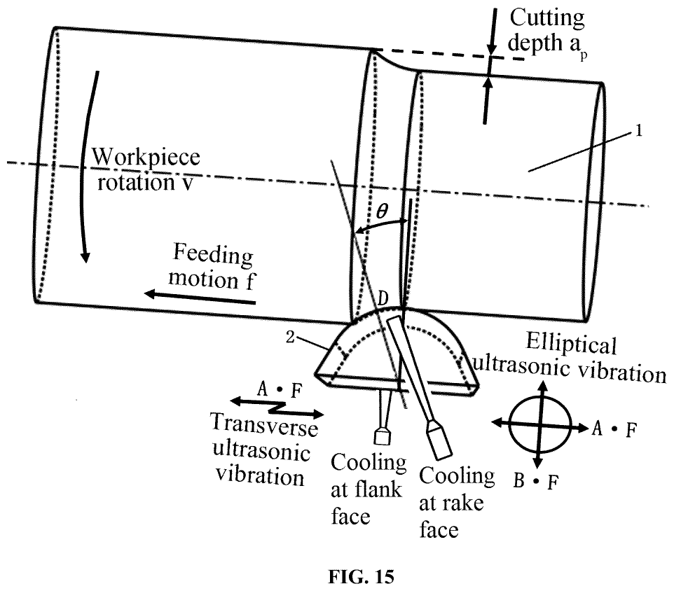

Taking cylindrical turning as an example, as shown in FIG. 15, f>2A, in a case that a vibration direction of the tool is parallel to the feed direction, a vibration equation of the tool is as follows:

z=A sin(2πFt),
where, F is ultrasonic vibration frequency, A is an actual ultrasonic vibration amplitude during turning, f is feed rate, tis time, and θ is an angle corresponding to an arc between point D on the cutting edge of the tool and a tool tip point. At point D on the cutting edge:
the heights of nominal wave ridges on the chip bottom surface and the machining surface are determined by the vibration amplitude, and are respectively as follows:

h_{c}=hₛ=2A sin θ; and
the heights of extruded wave ridges on the chip bottom surface and the machining surface are respectively as follows:

h_{cE}=2B sin θ

h_{sE}=2C sin θ

Both wave ridge formation and wave ridge extrusion are determined by ultrasonic vibration. From a perspective of vibration trajectory, a formed wave ridge will be completely extruded and removed, and a certain height of the wave ridge will be remained after extrusion due to rebounding of materials. Therefore, the height of the actually extruded wave ridge is less than the height of the nominal wave ridge. B and C are actually removed amplitudes after being extruded and rebounding at nominal amplitude A.

The heights of residual wave ridges on the chip bottom surface and the machining surface are respectively as follows:

$$\begin{matrix}{h}_{cR} = 2 ( A - B ) sin θ \\ {h}_{sR} = 2 ( A - C ) sin θ\end{matrix}$$

Maximum separation clearances between the rake face and the chip bottom surface, as well as between the flank face and the machining surface are respectively as follows:

C_{c}=h_{cE}

Cₛ=h_{sE}

Cycle lengths of nominal wave ridges on the chip bottom surface and the machining surface are respectively as follows:

$$\begin{matrix}{λ}_{c} = \frac{{v}_{ch}}{F} \\ {λ}_{s} = \frac{v}{F}\end{matrix}$$

where, ν_{ch} is flow speed of chips, and ν is cutting speed.

Duty cycles between the rake face and the chip bottom surface, as well as between the flank face and the machining surface in a separation stage are respectively as follows:

$$\begin{matrix}{D}_{c} = \frac{{λ}_{cE}}{{λ}_{c}} = \frac{{λ}_{cE} F}{{v}_{ch}} \\ {D}_{s} = \frac{{λ}_{sE}}{{λ}_{s}} = \frac{{λ}_{cE} F}{v}\end{matrix}$$

In this embodiment, in step 2, the ultrasonic vibration parameters and the cooling parameters are reasonably matched according to the cutting amount, that is, the condition for partial separation of the wave ridge is reasonably matched in a case that the cutting tool performs continuous cutting on the tool tip trajectory (for example, height and wavelength of the wave ridge are matched with tool face contact length and interference extrusion depth), so as to achieve better effects of increasing lubrication, reducing viscosity, and cooling on a cutting interface. Specifically, the condition for partial separation of the wave ridge between the rake face of the tool and the chip bottom surface is as follows: 0<C_{c}<G. The condition for partial separation of the wave ridge between the flank face of the tool and the machining surface is as follows: 0<Cₛ<G. Where, C_{c} and Cₛ are maximum separation clearances between the rake face and the chip bottom surface, as well as between the flank face and the machining surface, respectively. The wave ridge is obtained from vibration. As the amplitude of ultrasonic vibration is increased, the height of the nominal wave ridge is increased, the height of the extruded wave ridge is also increased, the maximum separation clearances between the rake face of the tool and the chip bottom surface, as well as between the flank face of the tool and the machining surface are increased, the capacity of cooling liquid entering the cutting areas is enhanced, and the effects of increasing lubrication, reducing viscosity, and cooling are enhanced. However, there is an optimum value for the height of the wave ridge. Excessive vibration impact is prone to cause the chip of a tool tip. The previously described G is an upper limit of the height of the extruded wave ridge.

According to the present technical solution, partial separation continuous high-speed ultrasonic vibration machining can be realized in processes of machining an aerospace difficult-to-machine material through step 1, step 2, and step 3 above, which completely breaks through the feed rate for producing cutting edge separation by a complete separation intermittent high-speed ultrasonic vibration cutting method (that is, high-speed precision interrupted ultrasonic vibration cutting method). Dynamically variable cutting thicknesses are achieved through transverse vibration or transverse component vibration perpendicular to the cutting speed in the machined surface during continuous cutting of the cutting edge, so that wave ridge structures are formed on the chip bottom surface and the machining surface to cause completely new partial separation of the wave ridge on the cutting interface and to completely break through a limitations on critical cutting parameters (the cutting speed, the feed rate, and the cutting depth). Compared with the existing ultrasonic machining technology (traditional one-dimensional ultrasonic machining, two-dimensional elliptical ultrasonic machining, and complete separation intermittent high-speed ultrasonic machining) and a conventional machining technology, the material removal rate is significantly increased. The wave ridge structures that open and close periodically improve the capacity of the cooling liquid entering the cutting areas, so that the cutting technology of the present technical solution also has many advantages of reducing the cutting force and the cutting heat, prolonging the tool life, reducing the machining cost, optimizing the surface quality, and improving the machining quality and the like compared with the prior art. The advantages of the above partial separation continuous high-speed ultrasonic vibration machining method in the present technical solution are specifically described below:

(1) The advantages of both the conventional one-dimensional ultrasonic vibration cutting and the elliptical ultrasonic vibration cutting are achieved under an extremely low cutting speed. The present technical solution breaks through maximum cutting speed limits of the traditional one-dimensional ultrasonic vibration cutting and elliptical ultrasonic vibration cutting. The advantages of the complete separation intermittent high-speed ultrasonic vibration cutting are all achieved at the feed rate of several micrometers per revolution. The present technical solution breaks through a limitation of the feed rate by the complete separation intermittent high-speed ultrasonic vibration cutting. According to the present technical solution, through an application of the above partial separation continuous high-speed ultrasonic vibration machining method, wave ridge separation between the tool and chips, as well as between the tool and a workpiece may be caused, so the cutting liquid is entered into a separation area for cooling and reducing wear to prolong the tool life, thereby still achieving the advantages of separated vibration cutting.

(2) Partial cutting area is opened, so that force and thermal conditions in the cutting area are improved. During conventional cutting, the rake face of the cutting tool is always in contact with the chip bottom surface, the actual clearance angle is 0° due to inevitable flank face wear. The flank face is also always in contact with the machined surface, so the cooling liquid is difficult to enter. FIG. 2 to FIG. 5 are schematic diagrams of wave ridge separation on a cutting interface. There are two stages of wave ridge separation and wave ridge extrusion in one wave ridge production cycle. In the wave ridge extrusion stage in one wave ridge production cycle, a tool face will interfere and extrude a formed wave ridge when a current wave ridge is formed. In the wave ridge separation stage in one wave ridge separation cycle, a clearance is formed between the tool face and the interfered, extruded, and rebounding wave ridge when a current wave ridge is formed, and then separation between faces occurs, but the tool tip does not separate. The cutting areas between the chip bottom surface and the rake face and between the flank face and the machining surface are periodically opened by wave ridge separation of the rake face and the flank face, which facilitates entering of the cutting liquid into the cutting areas to improve cutting conditions of the tool and the machining surface, increase lubrication, reduce wear, cool down, reduce force and heat, and is beneficial to prolonging the tool life and improving the surface quality of the workpiece.

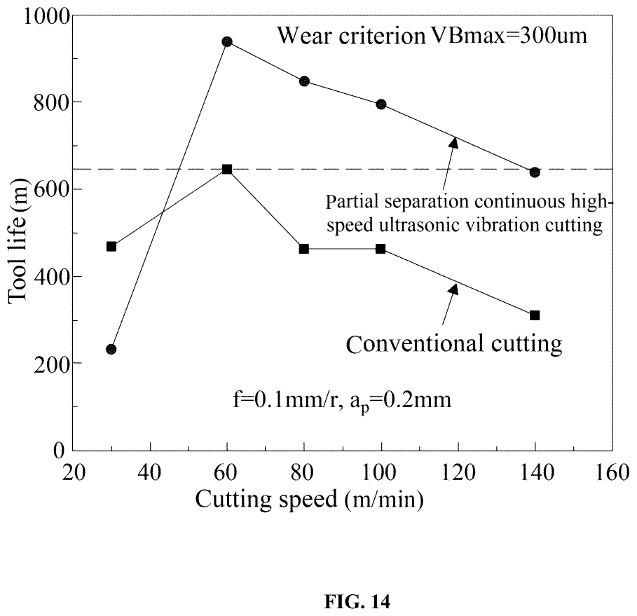

(3) The present technical solution breaks through a conventional cutting speed limit. Conventional cutting has a poor cooling effect, which leads to severe heat accumulation during high-speed cutting, and accelerates tool wear, so a conventional cutting speed can only ensure certain tool durability mostly in a low-speed cutting area of a corresponding material and a corresponding machining process, so that the machining efficiency is significantly limited. The partial separation continuous high-speed ultrasonic vibration machining of the present technical solution has a good cooling effect and heat accumulation is avoided. Under the same tool durability or surface quality, the cutting speed may reach service times that of conventional cutting to enter a high-speed cutting area of the corresponding material and the corresponding machining process, thereby significantly increasing the cutting efficiency, as shown in FIG. 14.

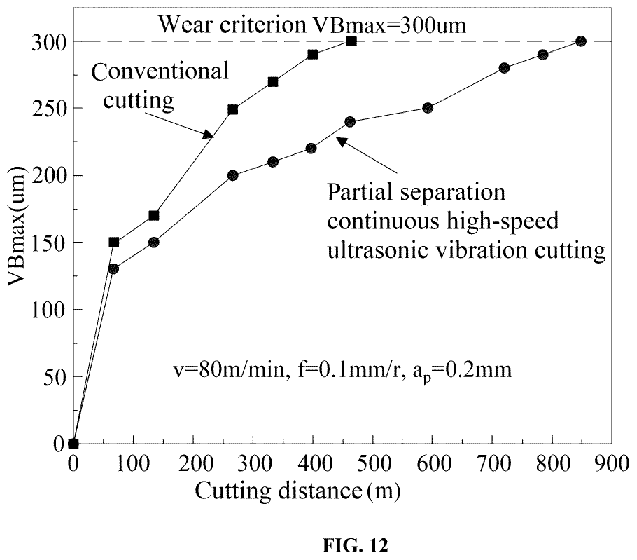

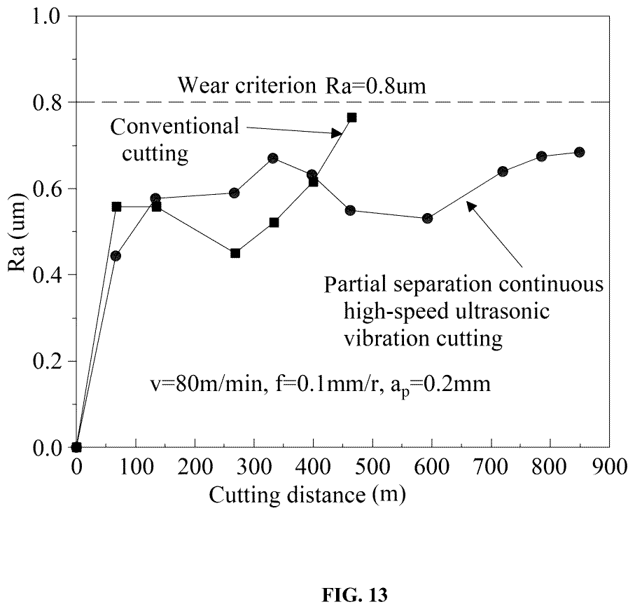

(4) The partial separation continuous high-speed ultrasonic vibration machining method in the present technical solution can delay the tool wear and prolong the tool life. As shown in FIG. 12 and FIG. 13, compared with conventional cutting, in an experiment of turning GH4169 (precipitation strengthened nickel based high-temperature alloy) using a coated cemented carbide tool under the conditions of cutting speed v=80 m/min, cutting depth aₚ=0.2 mm, feed rate f=0.1 mm/r, and high-pressure cooling under 80 bar, the partial separation continuous high-speed ultrasonic vibration machining method may significantly delay the wear rate of the tool. When a wear criterion is defined as VBₘₐₓ=0.3 and Rₐ=0.8, a cutting distance of the tool can be increased by 82.5%. A meaning of VBₘₐₓ is a maximum wear amount of the flank face.

(5) The partial separation continuous high-speed ultrasonic vibration machining method in the present technical solution can improve the machining efficiency. As shown in FIG. 14, taking VBₘₐₓ=0.3 and Rₐ=0.8 as finishing tool wear criterion, under the condition of the same cutting distance, compared with conventional cutting, in an experiment of turning GH4169 (precipitation strengthened nickel based high-temperature alloy) using the coated cemented carbide tool under the conditions of cutting depth aₚ=0.2 mm, feed rate f=0.1 mm/r, and high-pressure cooling under 80 bar, the machining efficiency of the partial separation continuous high-speed ultrasonic vibration machining method is improved by 1.33 times. The partial separation continuous high-speed ultrasonic vibration machining using the cutting speed of 140 m/min and conventional machining using the cutting speed of 60 min/m may cut equal distances/remove equal volumes of materials of the workpiece under the same tool wear.

(6) The partial separation continuous high-speed ultrasonic vibration machining method in the present technical solution can be applied to multiple cutting processes such as turning, milling, drilling, and grinding to achieve efficient finishing and precision machining of a complex part made of a difficult-to-machine material.

It can be seen that, by the present technical solution, partial separation continuous high-speed ultrasonic vibration machining further breaks through a limitation on a critical feed rate on the basis of breaking through a critical cutting speed in complete separation intermittent high-speed ultrasonic vibration machining through an application of the partial separation continuous high-speed ultrasonic vibration machining method, so that wave ridge separation between the tool and chip, as well as between the tool and the workpiece is caused, cutting liquid is entered into a separation area for cooling and reducing wear, and a cutting force and cutting heat can be reduced in cutting various aerospace difficult-to-machine materials, thereby significantly prolonging the tool life and increasing the material removal rate and improving the machining quality.

In the present technical solution, the application scope of the above partial separation continuous high-speed ultrasonic vibration machining method includes finishing and precision machining, and has multiple advantages as shown in FIG. 12, FIG. 13, and FIG. 14. In actual machining, vibration parameters (vibration form, vibration frequency, and vibration amplitude) as well as types and specifications of the ultrasonic tool holder need to be reasonably matched according to cutting parameters (cutting speed, feed rate, and cutting depth), materials of the workpiece and the tool, inner and outer contours of a part, and the like, so as to meet the conditions of wave ridges separation and the structural accessibility requirements of a tool holder.

### Embodiment 2

A flowchart of the partial separation continuous high-speed ultrasonic vibration machining method in Embodiment 1 is as shown in FIG. 1, which is suitable for machining methods such as turning, milling, grinding, drilling, reaming, and countersinking. To better explain the present disclosure to facilitate understanding, the present disclosure will be described in detail below through specific implementation 1 with reference to FIG. 15.

Implementation 1: A partial separation continuous high-speed ultrasonic vibration turning machining method is suitable for cylindrical turning, face turning, inner hole turning, grooving machining, cylindrical copying turning, cylindrical grooving machining, inner hole copying machining, inner hole grooving machining, and the like. FIG. 15 shows a principle of cylindrical turning based on this method. The method includes the following steps.

In step S1, a workpiece 1 is clamped to a spindle of a lathe.

In step S2, cutting parameters are set. Specifically, as an example, cylindrical finishing turning is performed on FGH96 (an existing alloy) by using a coated cemented carbide turning tool (a turning tool 2) at a cutting speed of 80 m/min, a feed rate of 0.2 mm/r, and a cutting depth of 0.1 mm.

In step S3, an ultrasonic turning tool holder is selected. A vibration method and a suitable ultrasonic turning tool holder are selected according to a cutting position of the workpiece 1. When the cutting position of the part is a single linear trajectory, one-directional vibration is preferred. When the cutting position of the part is in a complex shape, multi-directional composite vibration is selected. When the vibration direction is transverse ultrasonic vibration, the vibration direction is parallel to a feed direction of the turning tool 2. When the vibration is elliptical ultrasonic vibration, the vibration direction is a combination of a vibration component parallel to the feed direction and a vibration component parallel to a cutting depth direction, and a vibration plane of the elliptical ultrasonic vibration is parallel to a base surface of the tool (a condition that in the base surface of the tool, transverse direction or transverse component vibration of a cutting edge in the feed direction is induced is satisfied). For the example in step S2, a transverse vibration ultrasonic turning tool holder may be selected.

In step S4, vibration parameters are set. According to the cutting parameters, the vibration parameters may be set as follows: the vibration direction is transverse, a vibration frequency is 20 kHz, and an unilateral vibration amplitude is 6 μm.

In step S5, cooling parameters are set. For the example in step S2, a water soluble emulsion with a concentration of 8% is selected and sprayed to a rake face, or a flank face, or both the rake face and the flank face under a pressure of 50 bar.

In step 6, a high-pressure cooling system is started, an ultrasonic vibration system is started, and the machine tool is started, so that the partial separation continuous high-speed ultrasonic vibration turning can be completed.

### Embodiment 3

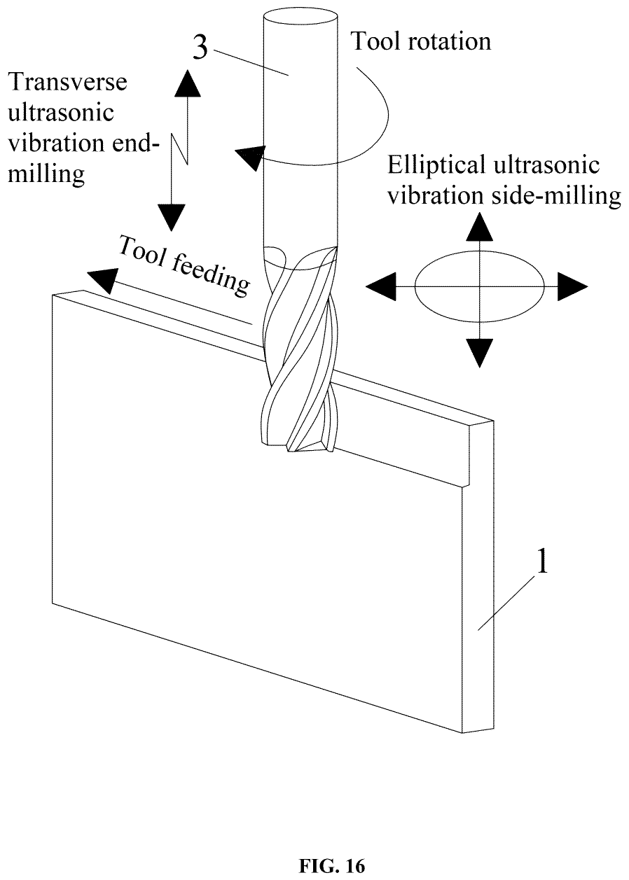

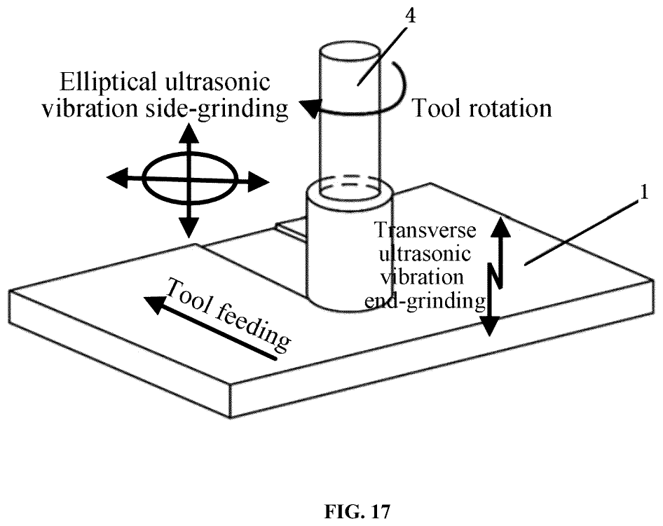

A flowchart of the partial separation continuous high-speed ultrasonic vibration machining method in Embodiment 1 is as shown in FIG. 1, which is suitable for machining methods such as turning, milling, grinding, drilling, reaming, and countersinking. To better explain the present disclosure to facilitate understanding, the present disclosure will be described in detail below through specific implementation 2 with reference to FIG. 16 and FIG. 17.

Implementation 2: A partial separation continuous high-speed ultrasonic vibration milling/grinding machining method is provided. FIG. 16 and FIG. 17 show principles of milling and grinding based on this method. The method includes the following steps.

In step S1, a workpiece 1 is fixed to a workbench of a milling/grinding machine.

In step S2, cutting parameters are set. Specifically, as an example, end milling is performed on TC4 (a titanium alloy material) by using a coated cemented carbide tool at a cutting speed of 120 m/min, a feed rate of 0.04 mm/tooth, a radial cutting width of 12 mm, and an axial cutting depth of 0.2 mm.

In step S3, an ultrasonic milling/grinding tool holder is selected. Referring to FIG. 16, when an end face is milled by using a bottom edge of a milling tool 3, a vibration direction of the tool is elliptical ultrasonic vibration. The elliptical ultrasonic vibration has a vibration component perpendicular to a cutting speed direction of each tooth of the milling tool 3. When the milling tool 3 is used for plunge-milling a rounded corner, the vibration direction of the tool is transverse ultrasonic vibration, and the ultrasonic vibration direction is perpendicular to the cutting speed direction of each tooth of the milling tool 3. Referring to FIG. 17, when a side surface of the workpiece 1 is ground by using abrasive particles on a side surface of a grinding head 4, a vibration of the grinding head 4 is elliptical ultrasonic vibration. The elliptical ultrasonic vibration has a vibration component perpendicular to a cutting speed direction of each abrasive particle of the grinding head 4. When an end face of the workpiece 1 is grounded by using abrasive particles on an end face of the grinding head 4, the vibration direction of the grinding head 4 is transverse ultrasonic vibration, and the transverse ultrasonic vibration is perpendicular to the cutting speed of each abrasive particle of the grinding head 4. For the example in step S2, an elliptical ultrasonic vibration milling tool holder may be selected.

In step S4, vibration parameters are set. According to the cutting parameters, the vibration parameters may be set as follows: the vibration is elliptical, a vibration frequency is 20 kHz, and unilateral vibration amplitudes of both paths are respectively 4 μm.

In step S5, cooling parameters are set. For the example in step S2, a water soluble emulsion with a concentration of 8% is selected and sprayed to a rake face, or a flank face, or both the rake face and the flank face under a pressure of 50 bar.

In step 6, a high-pressure cooling system is started, an ultrasonic vibration system is started, and the machine tool is started, so that the partial separation continuous high-speed ultrasonic vibration milling/grinding can be completed.

### Embodiment 4

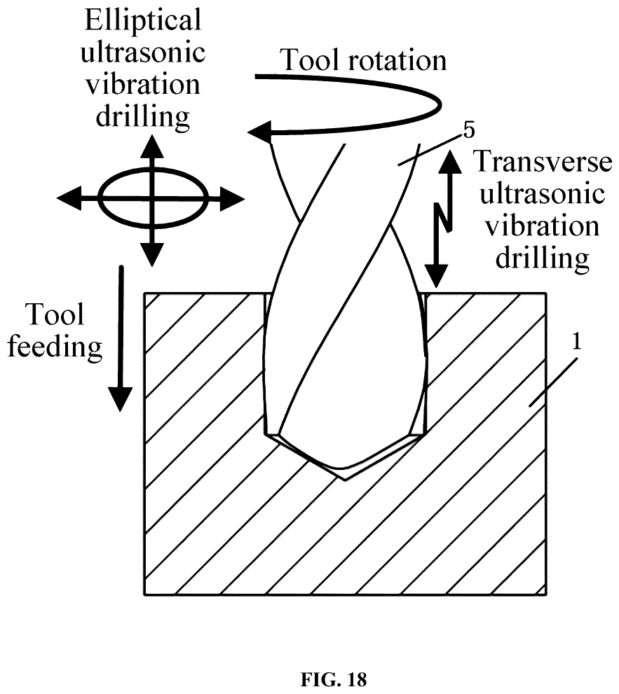

A flowchart of the partial separation continuous high-speed ultrasonic vibration machining method in Embodiment 1 is as shown in FIG. 1, which is suitable for machining methods such as turning, milling, grinding, drilling, reaming, and countersinking. To better explain the present disclosure to facilitate understanding, the present disclosure will be described in detail below through specific implementation 3 with reference to FIG. 18 to FIG. 20.

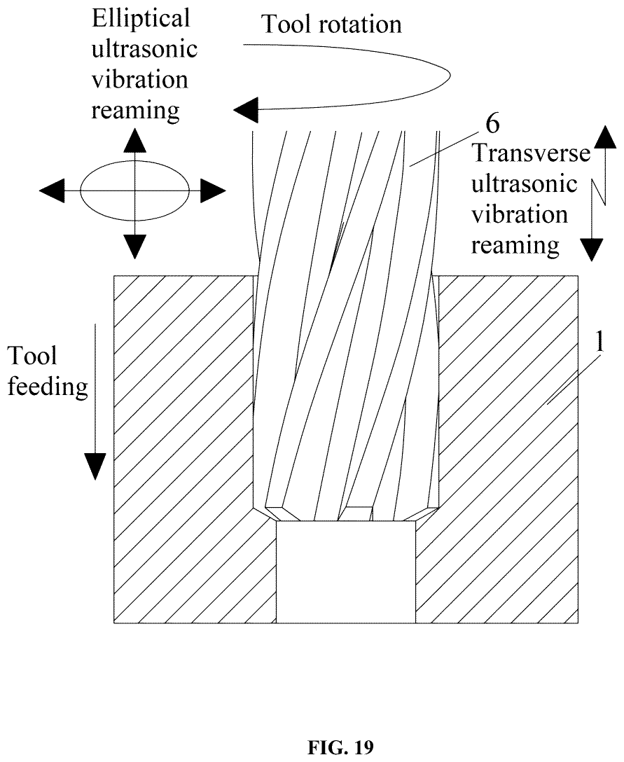

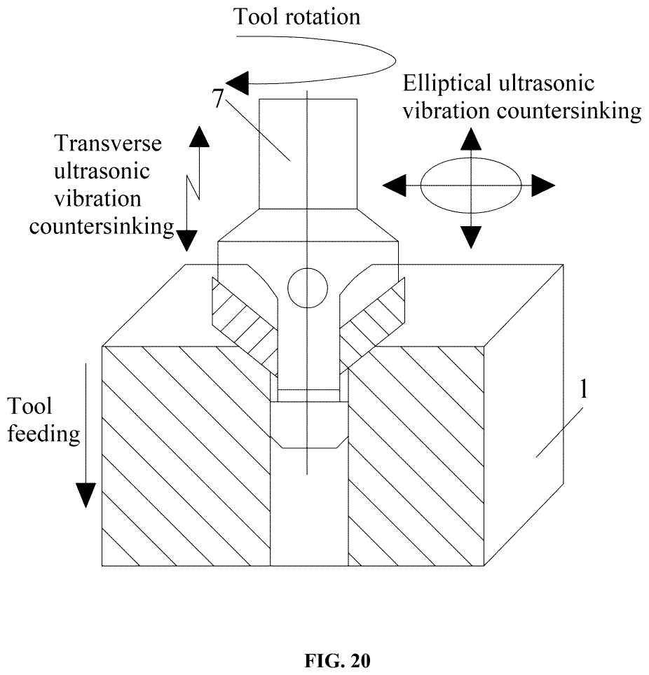

Implementation 3: A partial separation continuous high-speed ultrasonic vibration drilling/reaming/countersinking machining method is provided. FIG. 18, FIG. 19, and FIG. 20 show principles of drilling, reaming, and countersinking based on this method. The method includes the following steps.

In step S1, a workpiece 1 is fixed to a workbench of a machining center.

In step S2, cutting parameters are set. Specifically, as an example, drilling is performed on GH4169 by using a coated cemented carbide tool at a cutting speed of 100 m/min and a feed rate of 0.04 mm/tooth.

In step S3, an ultrasonic drilling/reaming/countersinking tool holder is selected. Referring to FIG. 18, when a vibration direction of a drilling bit 5 is transverse ultrasonic vibration, a vibration direction of the drilling bit 5 is perpendicular to a cutting speed direction and is parallel to a feed direction of the drilling bit 5. When the vibration of the drilling bit 5 is elliptical ultrasonic vibration, the elliptical ultrasonic vibration of the drilling bit 5 has a vibration component perpendicular to the cutting speed direction of a cutting edge of the drilling bit 5. Referring to FIG. 19, when a vibration direction of a reamer 6 is transverse ultrasonic vibration, a vibration direction of the reamer 6 is perpendicular to a cutting speed direction and is parallel to a feed direction of the reamer 6. When the vibration of the reamer 6 is elliptical ultrasonic vibration, the elliptical ultrasonic vibration of the reamer 6 has a vibration component perpendicular to the cutting speed direction of a cutting edge of the reamer 6. Referring to FIG. 20, when a vibration direction of a countersink drill 7 is transverse ultrasonic vibration, a vibration direction of the countersink drill 7 is perpendicular to a cutting speed direction and is parallel to a feed direction of the countersink drill 7. When the vibration of the countersink drill 7 is elliptical ultrasonic vibration, the elliptical ultrasonic vibration of the countersink drill 7 has a vibration component perpendicular to the cutting speed direction of a cutting edge of the countersink drill 7. For the example in step S2, a transverse ultrasonic vibration drill may be selected.

In step S4, vibration parameters are set. According to the cutting parameters, the vibration parameters may be set as follows: the vibration direction is transverse, a vibration frequency is 20 kHz, and an unilateral vibration amplitude is 6 μm.

In step S5, cooling parameters are set. For the example in step S2, a water soluble emulsion with a concentration of 8% is selected and sprayed to a rake face, or a flank face, or both the rake face and the flank face under a pressure of 50 bar.

In step 6, a high-pressure cooling system is started, an ultrasonic vibration system is started, and a machining center is started, so that the partial separation continuous high-speed ultrasonic vibration drilling/reaming/countersinking can be completed.

In conclusion, it can be known from Embodiment 1 to Embodiment 4 that according to the partial separation continuous high-speed ultrasonic vibration machining method proposed in the present technical solution, parts with different shapes can be machined through multiple cutting processes by using an ultrasonic power supply to excite cutting tools to induce transverse ultrasonic vibration or ultrasonic vibration with a transverse component and combining different vibration forms and cutting processes with types and shapes of parts. Limitations on critical cutting parameters (a cutting speed, a feed rate, and a cutting depth) are completely broken through. Compared with an existing ultrasonic machining technology and an conventional machining technology, the material removal rate is significantly improved. Meanwhile, many advantages of reducing the cutting force and the cutting heat, prolonging the tool life, reducing the machining cost, optimizing the surface quality, and improving the machining quality and the like are achieved.

The above descriptions are merely preferred embodiments of the present application, but are not intended to limit the present application. Any modification, equivalent replacement, improvement or the like made within the spirit and principle of the present application shall fall within the scope of protection of the present application.

What is claimed is:

1. A partial separation continuous high-speed ultrasonic vibration machining method, comprising:
step 1, mounting an ultrasonic vibration tool holder on a corresponding machine tool, in a base surface of a cutting tool, inducing transverse vibration or transverse component vibration of a cutting edge of the cutting tool on the ultrasonic vibration tool holder in a feed direction;
step 2, matching ultrasonic vibration parameters and cooling parameters according to cutting amount, so that a condition for partial separation of a wave ridge between a rake face of the cutting tool and a chip bottom surface, and/or between a flank face of the cutting tool and a machining surface is satisfied in a case that the cutting tool performs continuous cutting on a tool tip trajectory, wherein the cutting amount comprises three parameters: cutting speed, feed rate, and cutting depth of the cutting tool, the ultrasonic vibration parameters comprise three parameters: vibration amplitude, frequency, and vibration form, and the cooling parameters comprise three parameters: type of coolant, coolant pressure, and coolant application position; and
step 3, starting a cooling system, an ultrasonic vibration system, and the machine tool, and performing a partial separation continuous high-speed ultrasonic vibration machining process of the cutting tool on a workpiece.

2. The partial separation continuous high-speed ultrasonic vibration machining method according to claim 1, wherein the machine tool in step 1 is at least one of a lathe, a milling machine, a drilling machine, a grinding machine, and a machining center.

3. The partial separation continuous high-speed ultrasonic vibration machining method according to claim 1, wherein the cutting tool in step 1 includes at least one of a turning tool, a milling tool, a drilling bit, a grinding head, a reamer, and a countersink drill.

4. The partial separation continuous high-speed ultrasonic vibration machining method according to claim 3, wherein the ultrasonic vibration tool holder in step 1 includes at least one of a turning tool holder, a milling tool holder, a drilling bit holder, a grinding head holder, a reamer holder, and a countersink drill holder.

5. The partial separation continuous high-speed ultrasonic vibration machining method according to claim 1, wherein the cutting tool in step 1 is made of at least one of cemented carbide, ceramic, cermet, cubic boron nitride, and diamond.

6. The partial separation continuous high-speed ultrasonic vibration machining method according to claim 1, wherein in a case that the partial separation continuous high-speed ultrasonic vibration machining method is combined with a turning method, both a partial separation continuous high-speed transverse ultrasonic vibration turning method and a partial separation continuous high-speed elliptical ultrasonic vibration turning method are comprised; in a case that the partial separation continuous high-speed ultrasonic vibration machining method is combined with a milling method, both a partial separation continuous high-speed elliptical ultrasonic vibration milling method and a partial separation continuous high-speed transverse ultrasonic vibration plunge milling method are comprised; in a case that the partial separation continuous high-speed ultrasonic vibration machining method is combined with a grinding method, both a partial separation continuous high-speed elliptical ultrasonic vibration grinding method and a partial separation continuous high-speed transverse ultrasonic vibration grinding method are comprised; in a case that the partial separation continuous high-speed ultrasonic vibration machining method is combined with a drilling method, both a partial separation continuous high-speed elliptical ultrasonic vibration drilling method and a partial separation continuous high-speed transverse ultrasonic vibration drilling method are comprised; in a case that the partial separation continuous high-speed ultrasonic vibration machining method is combined with a reaming method, both a partial separation continuous high-speed transverse ultrasonic vibration reaming method and a partial separation continuous high-speed elliptical ultrasonic vibration reaming method are comprised; and in a case that the partial separation continuous high-speed ultrasonic vibration machining method is combined with a countersinking method, both a partial separation continuous high-speed transverse ultrasonic vibration countersinking method and a partial separation continuous high-speed elliptical ultrasonic vibration countersinking method are comprised.

7. The partial separation continuous high-speed ultrasonic vibration machining method according to claim 6, wherein in a case that the partial separation continuous high-speed ultrasonic vibration machining method is used for cylindrical turning, f>2A, and in a case that a vibration direction of the cutting tool is parallel to the feed direction, a vibration equation of the cutting tool is:
Z=A sin(2πFt),
wherein, F is ultrasonic vibration frequency, A is actual ultrasonic vibration amplitude during turning, f is feed rate, tis time, and θ is an angle corresponding to an arc between point D on the cutting edge of the cutting tool and a tool tip point; at point D on the cutting edge:
heights of nominal wave ridges on the chip bottom surface and the machining surface are respectively as follows:
h_{c}=2A sin θ;
hₛ=2A sin θ;
heights of extruded wave ridges on the chip bottom surface and the machining surface are respectively as follows:
h_{cE}=2B sin θ;
h_{sE}=2C sin θ;
heights of residual wave ridges on the chip bottom surface and the machining surface are respectively as follows:
$$\begin{matrix}{h}_{cR} = 2 ( A - B ) sin θ ; \\ {h}_{sR} = 2 ( A - C ) sin θ ;\end{matrix}$$
wherein, B and C are actually removed amplitudes after being extruded and rebounding at nominal amplitude A;
maximum separation clearances between the rake face and the chip bottom surface, as well as between the flank face and the machining surface are respectively:
C_{c}=h_{cE};
Cₛ=h_{sE};
cycle lengths of the nominal wave ridges on the chip bottom surface and the machining surface are respectively as follows:
$$\begin{matrix}{λ}_{c} = \frac{{v}_{ch}}{F} ; \\ {λ}_{s} = \frac{v}{F} ;\end{matrix}$$
wherein, ν_{ch} is flow speed of chips, and ν is cutting speed; and
duty cycles between the rake face and the chip bottom surface, as well as between the flank face and the machining surface in a separation stage are respectively as follows:
$$\begin{matrix}{D}_{c} = \frac{{λ}_{cE}}{{λ}_{c}} = \frac{{λ}_{cE} F}{{v}_{ch}} \\ {D}_{s} = \frac{{λ}_{sE}}{{λ}_{s}} = \frac{{λ}_{cE} F}{v}\end{matrix}$$

8. The partial separation continuous high-speed ultrasonic vibration machining method according to claim 7, wherein the condition for partial separation of the wave ridge between the rake face of the cutting tool and the chip bottom surface is as follows:
0<C_{c}<G; and
the condition for partial separation of the eave ridge between the flank face of the cutting tool and the machining surface is as follows:
0<Cₛ<G,
wherein, G is an upper limit of the height of the extruded wave ridge.

9. The partial separation continuous high-speed ultrasonic vibration machining method according to claim 1, wherein direction of the transverse vibration or the transverse component vibration in step 1 is perpendicular to the cutting speed of the cutting tool, and vibration forms of the transverse vibration or the transverse component vibration include one-dimensional vibration, two-dimensional vibration, three-dimensional vibration, or elliptical vibration.

10. The partial separation continuous high-speed ultrasonic vibration machining method according to claim 1, wherein the type of coolant includes at least one of oil-based cutting liquid, oil-based cutting mist, water-based cutting liquid, water-based cutting mist, liquid nitrogen, and air; and in step 3, when the cooling system is started, a coolant is capable of being sprayed to a cutting area from the rake face of the cutting tool, the flank face of the cutting tool, or both the rake face of the cutting tool and the flank face of the cutting tool.

11. The partial separation continuous high-speed ultrasonic vibration machining method according to claim 2, wherein the cutting tool in step 1 is made of at least one of cemented carbide, ceramic, cermet, cubic boron nitride, and diamond.

12. The partial separation continuous high-speed ultrasonic vibration machining method according to claim 3, wherein the cutting tool in step 1 is made of at least one of cemented carbide, ceramic, cermet, cubic boron nitride, and diamond.

13. The partial separation continuous high-speed ultrasonic vibration machining method according to claim 4, wherein the cutting tool in step 1 is made of at least one of cemented carbide, ceramic, cermet, cubic boron nitride, and diamond.

14. The partial separation continuous high-speed ultrasonic vibration machining method according to claim 2, wherein in a case that the partial separation continuous high-speed ultrasonic vibration machining method is combined with a turning method, both a partial separation continuous high-speed transverse ultrasonic vibration turning method and a partial separation continuous high-speed elliptical ultrasonic vibration turning method are comprised; in a case that the partial separation continuous high-speed ultrasonic vibration machining method is combined with a milling method, both a partial separation continuous high-speed elliptical ultrasonic vibration milling method and a partial separation continuous high-speed transverse ultrasonic vibration plunge milling method are comprised; in a case that the partial separation continuous high-speed ultrasonic vibration machining method is combined with a grinding method, both a partial separation continuous high-speed elliptical ultrasonic vibration grinding method and a partial separation continuous high-speed transverse ultrasonic vibration grinding method are comprised; in a case that the partial separation continuous high-speed ultrasonic vibration machining method is combined with a drilling method, both a partial separation continuous high-speed elliptical ultrasonic vibration drilling method and a partial separation continuous high-speed transverse ultrasonic vibration drilling method are comprised; in a case that the partial separation continuous high-speed ultrasonic vibration machining method is combined with a reaming method, both a partial separation continuous high-speed transverse ultrasonic vibration reaming method and a partial separation continuous high-speed elliptical ultrasonic vibration reaming method are comprised; and in a case that the partial separation continuous high-speed ultrasonic vibration machining method is combined with a countersinking method, both a partial separation continuous high-speed transverse ultrasonic vibration countersinking method and a partial separation continuous high-speed elliptical ultrasonic vibration countersinking method are comprised.

15. The partial separation continuous high-speed ultrasonic vibration machining method according to claim 3, wherein in a case that the partial separation continuous high-speed ultrasonic vibration machining method is combined with a turning method, both a partial separation continuous high-speed transverse ultrasonic vibration turning method and a partial separation continuous high-speed elliptical ultrasonic vibration turning method are comprised; in a case that the partial separation continuous high-speed ultrasonic vibration machining method is combined with a milling method, both a partial separation continuous high-speed elliptical ultrasonic vibration milling method and a partial separation continuous high-speed transverse ultrasonic vibration plunge milling method are comprised; in a case that the partial separation continuous high-speed ultrasonic vibration machining method is combined with a grinding method, both a partial separation continuous high-speed elliptical ultrasonic vibration grinding method and a partial separation continuous high-speed transverse ultrasonic vibration grinding method are comprised; in a case that the partial separation continuous high-speed ultrasonic vibration machining method is combined with a drilling method, both a partial separation continuous high-speed elliptical ultrasonic vibration drilling method and a partial separation continuous high-speed transverse ultrasonic vibration drilling method are comprised; in a case that the partial separation continuous high-speed ultrasonic vibration machining method is combined with a reaming method, both a partial separation continuous high-speed transverse ultrasonic vibration reaming method and a partial separation continuous high-speed elliptical ultrasonic vibration reaming method are comprised; and in a case that the partial separation continuous high-speed ultrasonic vibration machining method is combined with a countersinking method, both a partial separation continuous high-speed transverse ultrasonic vibration countersinking method and a partial separation continuous high-speed elliptical ultrasonic vibration countersinking method are comprised.

16. The partial separation continuous high-speed ultrasonic vibration machining method according to claim 4, wherein in a case that the partial separation continuous high-speed ultrasonic vibration machining method is combined with a turning method, both a partial separation continuous high-speed transverse ultrasonic vibration turning method and a partial separation continuous high-speed elliptical ultrasonic vibration turning method are comprised; in a case that the partial separation continuous high-speed ultrasonic vibration machining method is combined with a milling method, both a partial separation continuous high-speed elliptical ultrasonic vibration milling method and a partial separation continuous high-speed transverse ultrasonic vibration plunge milling method are comprised; in a case that the partial separation continuous high-speed ultrasonic vibration machining method is combined with a grinding method, both a partial separation continuous high-speed elliptical ultrasonic vibration grinding method and a partial separation continuous high-speed transverse ultrasonic vibration grinding method are comprised; in a case that the partial separation continuous high-speed ultrasonic vibration machining method is combined with a drilling method, both a partial separation continuous high-speed elliptical ultrasonic vibration drilling method and a partial separation continuous high-speed transverse ultrasonic vibration drilling method are comprised; in a case that the partial separation continuous high-speed ultrasonic vibration machining method is combined with a reaming method, both a partial separation continuous high-speed transverse ultrasonic vibration reaming method and a partial separation continuous high-speed elliptical ultrasonic vibration reaming method are comprised; and in a case that the partial separation continuous high-speed ultrasonic vibration machining method is combined with a countersinking method, both a partial separation continuous high-speed transverse ultrasonic vibration countersinking method and a partial separation continuous high-speed elliptical ultrasonic vibration countersinking method are comprised.

17. The partial separation continuous high-speed ultrasonic vibration machining method according to claim 2, wherein direction of the transverse vibration or the transverse component vibration in step 1 is perpendicular to the cutting speed of the cutting tool, and vibration forms of the transverse vibration or the transverse component vibration include one-dimensional vibration, two-dimensional vibration, three-dimensional vibration, or elliptical vibration.

18. The partial separation continuous high-speed ultrasonic vibration machining method according to claim 3, wherein direction of the transverse vibration or the transverse component vibration in step 1 is perpendicular to the cutting speed of the cutting tool, and vibration forms of the transverse vibration or the transverse component vibration include one-dimensional vibration, two-dimensional vibration, three-dimensional vibration, or elliptical vibration.

19. The partial separation continuous high-speed ultrasonic vibration machining method according to claim 2, wherein the type of coolant includes at least one of oil-based cutting liquid, oil-based cutting mist, water-based cutting liquid, water-based cutting mist, liquid nitrogen, and air; and in step 3, when the cooling system is started, a coolant is capable of being sprayed to a cutting area from the rake face of the cutting tool, the flank face of the cutting tool, or both the rake face of the cutting tool and the flank face of the cutting tool.

20. The partial separation continuous high-speed ultrasonic vibration machining method according to claim 3, wherein the type of coolant includes at least one of oil-based cutting liquid, oil-based cutting mist, water-based cutting liquid, water-based cutting mist, liquid nitrogen, and air; and in step 3, when the cooling system is started, a coolant is capable of being sprayed to a cutting area from the rake face of the cutting tool, the flank face of the cutting tool, or both the rake face of the cutting tool and the flank face of the cutting tool.
